(19) United States
(12) Patent Application Publication
(10) Pub. No.: US 2021/0053334 A1
(43) Pub. Date: Feb. 25, 2021

(54) LAMINATION JIG AND ULTRA-THIN GLASS LAMINATING METHOD USING THE SAME

(71) Applicant: SILICON DISPLAY TECHNOLOGY, Yongin-si (KR)

(72) Inventors: Daebong SEO, Yongin-si (KR); Byungchan SEO, Suwon-si (KR); Junseo KIM, Hwaseong-si (KR); Jun HUR, Hwaseong-si (KR); Jimin SO, Yongin-si (KR); Yejun HAN, Suwon-si (KR); Hoemin JUNG, Yongin-si (KR); Jin Hyeong YU, Yongin-si (KR); Kwanwon LIM, Yongin-si (KR)

(21) Appl. No.: 16/984,438

(22) Filed: Aug. 4, 2020

(30) Foreign Application Priority Data
Aug. 19, 2019 (KR) 10-2019-0101103

(51) Int. Cl. B32B 37/00; B32B 37/10; B32B 37/12

(52) U.S. Cl. CPC B32B 37/0053; B32B 37/0038; B32B 37/10; B32B 2305/34; B32B 2037/1253; B32B 2457/00; B32B 37/1284

(57) ABSTRACT

A lamination jig according to an exemplary embodiment of the present invention includes: a base plate having a predetermined depth, and including at least one substrate mounting unit into which the substrate is inserted and fixed; and at least one discharging hole installed in the base plate and at least part thereof overlapping the substrate mounting unit.

### CROSS-REFERENCE TO RELATED APPLICATION

This application claims priority to and the benefit of Korean Patent Application No. 10-2019-0101103 filed in the Korean Intellectual Property Office on Aug. 19, 2019, the entire contents of which are incorporated herein by reference.

### BACKGROUND OF THE INVENTION

### (a) Field of the Invention

The present disclosure relates to a lamination jig and an ultra-thin glass laminating method using the same.

### (b) Description of the Related Art

It is gradually becoming an important target to manufacture more lightweight, thinner, and more flexible electronic elements such as sensors or display devices, and attempts have been made to use ultra-thin glass as a passivation layer or a cover layer of the electronic elements.

However, the ultra-thin glass is very thin, so it may be broken or defects thereof may be generated during a transfer process or a lamination process.

To prevent the generation of defects during a transfer, a method for using an adhesive to laminate ultra-thin glass to a carrier substrate, laminating the same to the electronic element, and then separating the ultra-thin glass and the carrier substrate is disclosed, but defects may be generated when the ultra-thin glass is separated from the carrier substrate.

A lamination process for laminating the ultra-thin glass to the electronic element may be a process for applying an adhesive to the electronic element, positioning the ultra-thin glass on the adhesive, and pressurizing the same, and during this pressurizing process, the adhesive may be leaked to generate defects in the electronic element or contaminate the ultra-thin glass or the substrate.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a lamination jig and an ultra-thin glass laminating method using the same for improving handling of ultra-thin glass.

The present invention has been made in another effort to provide a lamination jig and an ultra-thin glass laminating method using the same for minimizing damage to the ultra-thin glass.

The present invention has been made in another effort to provide a lamination jig and an ultra-thin glass laminating method using the same for improving stability and reliability of ultra-thin glass.

The present invention has been made in another effort to provide a lamination jig and an ultra-thin glass laminating method using the same for reducing a manufacturing cost of a laminate structure.

The present invention has been made in another effort to provide a lamination jig and an ultra-thin glass laminating method using the same for minimizing leakage of an adhesive material and generation of defects to an electronic element.

The present invention has been made in another effort to provide a lamination jig and an ultra-thin glass laminating method using the same for minimizing leakage of an adhesive material and contamination of ultra-thin glass and a substrate.

An exemplary embodiment of the present invention may be used to achieve objects which are not specifically mentioned other than the above-mentioned objects.

An exemplary embodiment of the present invention provides a lamination jig including: a base plate having a predetermined depth, and including at least one substrate mounting unit into which the substrate is inserted and fixed; and at least one discharging hole installed in the base plate with at least part thereof overlapping the substrate mounting unit.

The discharging hole may be positioned on a boundary of the substrate mounting unit and part thereof may overlap the substrate mounting unit.

The discharging hole may be positioned on the substrate mounting unit and may entirely overlap the substrate mounting unit.

An adhesive may be applied to the substrate fixed to the substrate mounting unit, the ultra-thin glass may be positioned on the adhesive, pressure may be applied to the substrate and the ultra-thin glass, and part of the adhesive may be discharged to the discharging hole.

The base plate may include a plurality of the substrate mounting units, and the substrate mounting units may have different sizes or shapes.

The base plate may include a plurality of the discharging holes, and the discharging holes may have different sizes or shapes.

Another embodiment of the present invention provides an ultra-thin glass laminating method including: mounting a substrate on which an electronic element is installed on one side on a lamination jig; laminating ultra-thin glass on a flexible film; applying an adhesive to at least part of the one side of the substrate; disposing the flexible film so that the side to which the ultra-thin glass is laminated may face the one side of the substrate on the flexible film, and laminating the ultra-thin glass to the substrate to which the adhesive is applied; separating the flexible film from the ultra-thin glass; and forming a laminate structure by pressurizing the substrate and the ultra-thin glass.

The lamination jig may include a base plate having a predetermined depth and including at least one substrate mounting unit into which the substrate is inserted and fixed, and at least one discharging hole installed in the base plate and at least part thereof overlapping the substrate mounting unit.

A thickness of the ultra-thin glass may be 1 μm to 100 μm.

The laminating of ultra-thin glass on a flexible film may include applying a liquid material to the flexible film, disposing the ultra-thin glass on the liquid material, and pressurizing the flexible film and the ultra-thin glass to laminate the flexible film and the ultra-thin glass.

The liquid material may include a high-volatility organic solvent.

The forming of a laminate structure may include allowing part of the adhesive to be discharged to the discharging hole while pressurizing the substrate and the ultra-thin glass.

The forming of a laminate structure may include pressurizing the substrate and the ultra-thin glass while allowing the lamination jig to pass between a pair of rollers.

The ultra-thin glass may be covered with an absorbing sheet, the lamination jig may be passed between the one pair of rollers, the substrate and the ultra-thin glass may be pressurized, part of the adhesive may leak and may be absorbed into the absorbing sheet, and adherence may be generated between the absorbing sheet and the ultra-thin glass by the adhesive absorbed into the absorbing sheet.

The laminate structure may include the substrate, the ultra-thin glass, and an adhesive layer positioned between the substrate and the ultra-thin glass and formed by curing the adhesive.

A thickness of the adhesive layer may be 1 μm to 20 μm.

The predetermined depth may be equal to or greater than a summation of thicknesses of the substrate, the electronic element, the ultra-thin glass, and the adhesive layer.

The ultra-thin glass laminating method may further include, before laminating the ultra-thin glass to the substrate to which the adhesive is applied, performing a washing step for removing a contaminated material from a surface of the ultra-thin glass.

The electronic element may include a fingerprint sensor.

The lamination jig and the ultra-thin glass laminating method using the same according to the exemplary embodiment of the present invention may improve handling of ultra-thin glass, may minimize the damage of the ultra-thin glass, may improve stability and reliability of the ultra-thin glass, may reduce the manufacturing cost of the laminate structure, and may minimize generation of defects to the electronic element after the adhesive material is leaked and contamination of the ultra-thin glass and the substrate.

### BRIEF DESCRIPTION OF THE DRAWINGS

FIG. 1 shows a lamination jig according to an exemplary embodiment.

FIG. 2 shows a cross-section with respect to a line A-A′ of FIG. 1.

FIG. 3 to FIG. 8 show an ultra-thin glass laminating method according to an exemplary embodiment.

FIG. 9 shows a cross-section with respect to a line B-B′ of FIG. 8.

FIG. 10 shows an example of a laminate structure formed by an ultra-thin glass laminating method according to an exemplary embodiment.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive, and like reference numerals designate like elements throughout the specification. Further, a detailed description of a well-known related art will be omitted.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. When an element is referred to as being “directly on” another element, there are no intervening elements present. On the contrary, it will be understood that when an element such as a layer, film, region, or substrate is referred to as being “below” another element, it can be directly below the other element or intervening elements may also be present. When an element is referred to as being “directly below” another element, there are no intervening elements present.

Unless explicitly described to the contrary, the word “comprise” and variations such as “comprises” or “comprising” will be understood to imply the inclusion of stated elements but not the exclusion of any other elements.

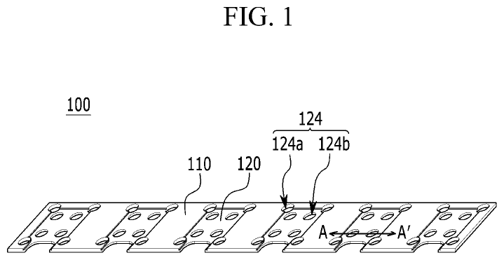

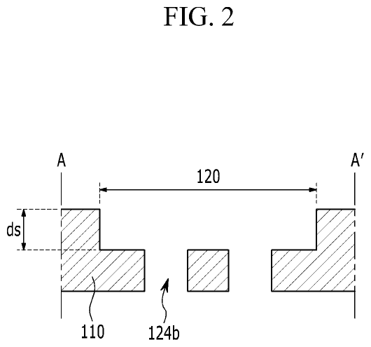

FIG. 1 shows a lamination jig according to an exemplary embodiment, and FIG. 2 shows a cross-section with respect to a line A-A′ of FIG. 1.

The lamination jig according to exemplary embodiments is used to stably laminate or adhere ultra-thin glass that is about 1 μm to 20 μm thick to the substrate of which one side is provided an electronic element. Here, the electronic element may be a human body sensor such as a fingerprint sensor or a circuit element such as a thin film transistor, and it is not limited as long as the ultra-thin glass may be applied.

Referring to FIG. 1 and FIG. 2, the lamination jig 100 has a predetermined depth (dₛ), and it includes a base plate 110 including at least one substrate mounting unit 120 into which a substrate is inserted and to which the same is fixed, and a discharging hole 124 at least one of which is provided to the base plate 110 and at least part of which overlaps the substrate mounting unit 120.

The lamination jig 100 includes a base plate 110 and at least one substrate mounting unit 120 provided on the base plate 110, and the drawings show six substrate mounting units 120, and without being limited thereto, a lesser number or a greater number of substrate mounting units 120 may be installed on the base plate 110. Also, a shape or a size of the substrate mounting unit 120 may be designed in various ways corresponding to the shape or the size of the substrate. In addition, when a plurality of substrate mounting units 120 are on the base plate 110, the plurality of substrate mounting units 120 may have different sizes or shapes, and in this case, a laminate structure with various sizes or shapes may be formed.

On the base plate 110, the substrate mounting unit 120 has a predetermined depth (dₛ), so it may form a step on a portion that is not the substrate mounting unit 120. The predetermined depth (dₛ) may be set corresponding to a thickness of the substrate to which the ultra-thin glass will be laminated, a thickness of the ultra-thin glass, and thicknesses of an element layer, an adhesive layer, and a passivation layer between the substrate and the ultra-thin glass.

Because of the above-noted step, the fixed substrate may stably maintain durability and reliability during a process, accurate alignment is allowable during an ultra-thin glass lamination process, a misalignment by which the ultra-thin glass shifts may be prevented, and breaking of the ultra-thin glass or generation of defects thereof may be minimized.

The substrate may be a glass substrate with one side on which an electronic element is formed, but it is not limited thereto. The substrate may be fixed to the substrate mounting unit 120 so as to laminate the ultra-thin glass.

The discharging hole 124 may be a discharging passage of the adhesive material that may leak or flow to other constituent elements during the process for laminating the ultra-thin glass and forming a laminate structure. The adhesive material that leaks during the lamination process may, for example, contact the electronic element to generate defects or may contaminate the substrate or the ultra-thin glass surface, so it is needed to be removed. During the process for applying an adhesive to the substrate fixed to the substrate mounting unit 120, positioning the ultra-thin glass on the adhesive, and pressurizing the substrate and the ultra-thin glass to laminate the ultra-thin glass to the substrate, the adhesive may leak during the pressurization, and the leaked adhesive is discharged to the discharging hole and is removed, so generation of defects of elements or contamination on the surface may be minimized.

A discharging hole 124a may be positioned on a boundary portion of the substrate mounting unit 120. In this case, part of the discharging hole 124a may overlap the substrate mounting unit 120. It is shown in FIG. 1 that the substrate mounting unit 120 is quadrangular in a plan view and four discharging holes 124a are positioned for each apex of the quadrangle, but the substrate mounting unit 120 according to exemplary embodiments may have different shapes, a various number of the discharging holes 124a may be disposed on various positions on the boundary portion of the substrate mounting unit 120, and the leaking adhesive material may be discharged through the same.

The discharging hole 124b may be positioned inside the boundary portion of the substrate mounting unit 120, and in this case, the entire discharging hole 124b may overlap the substrate mounting unit 120. In a like manner, the number or the position of a discharging hole 124b is not limited to the illustrated number or the position.

When the base plate 110 includes a plurality of discharging holes 124, the discharging holes 124 may have different sizes or shapes if needed. Further, when a plurality of discharging holes 124 overlap one substrate mounting unit 120, the sizes or the shapes of the overlapping discharging holes 124 may be the same or different, and may be different from the sizes or the shapes of the discharging holes 124 overlapping the adjacent substrate mounting unit 120.

Hereinafter, an ultra-thin glass laminating method using the above-described lamination jig will be described.

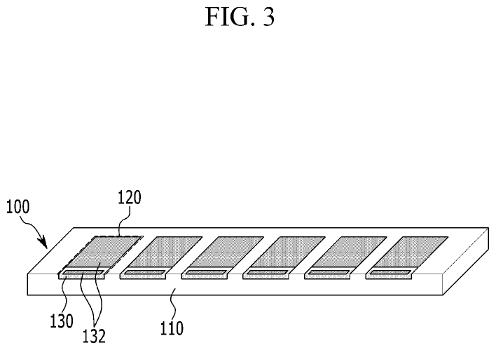

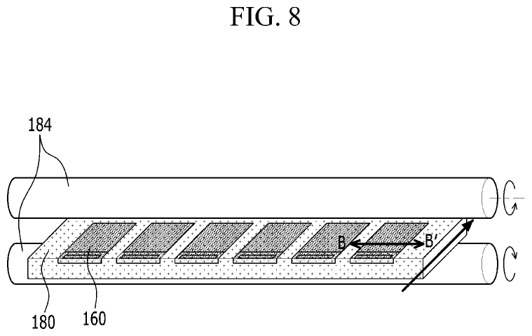

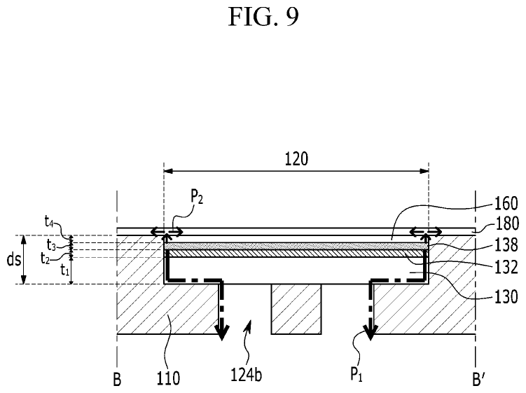

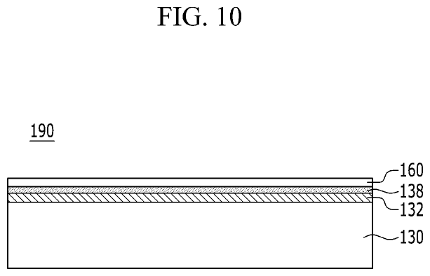

FIG. 3 to FIG. 8 show an ultra-thin glass laminating method according to an exemplary embodiment, FIG. 9 shows a cross-section with respect to a line B-B′ of FIG. 8, and FIG. 10 shows an example of a laminate structure formed by an ultra-thin glass laminating method according to an exemplary embodiment.

Referring to FIG. 3 to FIG. 10, the ultra-thin glass laminating method includes: mounting a substrate 130 with a side on which an electronic element 132 is installed on a lamination jig 100; laminating ultra-thin glass 160 to a flexible film 150; applying an adhesive 136 to at least part of the one side of the substrate 130; laminating the ultra-thin glass 160 to the substrate 130 on which the adhesive 136 is applied; separating the flexible film from the ultra-thin glass; and forming a laminate structure 190 by pressurizing the substrate 130 and the ultra-thin glass 160.

Here, the thickness of the ultra-thin glass 160 may be about 1 μm to about 100 μm, and further preferably about 1 μm to about 20 μm, which may be relatively very thin compared to the ultra-thin glass used in the conventional electronic element. By this, the ultra-thin glass 160 according to exemplary embodiments has a higher possibility of being broken or damaged compared to the ultra-thin glass used in the conventional electronic element, and it may have a higher possibility of being damaged during a transferring or laminating process. Therefore, it is essential to develop a method for laminating the ultra-thin glass 160 to the substrate 130 on which the electronic element 132 is mounted without damage.

First, the substrate 130 is mounted on the lamination jig 100 (refer to FIG. 3).

The substrate 130 may be an organic substrate, an electronic element 132 is formed on one side of the substrate 130, and the electronic element 132 may include a biometric sensor such as a fingerprint sensor or a circuit element such as a thin film transistor.

The substrate 130 is mounted on the substrate mounting unit 120 of the lamination jig 100 and is then fixed thereto, it contacts the substrate mounting unit 120 on another side where no electronic element 132 is formed on the substrate 130, and the electronic element 132 is exposed.

The lamination jig 100 according to an exemplary embodiment may include a plurality of substrate mounting units 120, so the ultra-thin glass 160 may be simultaneously laminated to a plurality of substrates 130, thereby reducing a manufacturing time and cost.

The substrate mounting unit 120 forms a step with a predetermined depth (dₛ), the substrate 130 may be firmly fixed to the substrate mounting unit 120 by the step, accurate alignment of the ultra-thin glass 160 is accordingly allowable, durability and reliability of the substrate 130 and the electronic element 132 may be maintained while performing the lamination process, and breaking of the ultra-thin glass 160 or generation of defects on the ultra-thin glass 160 during the process may be minimized.

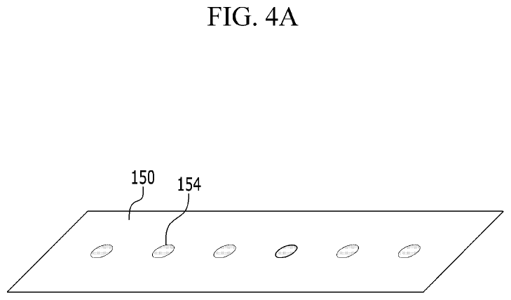

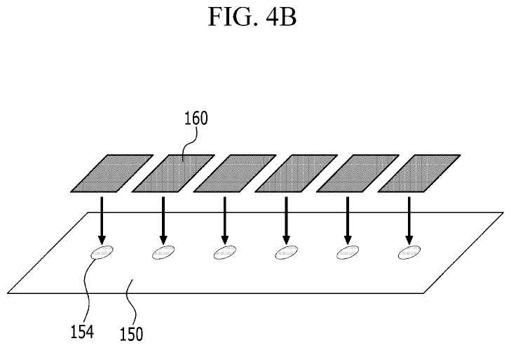

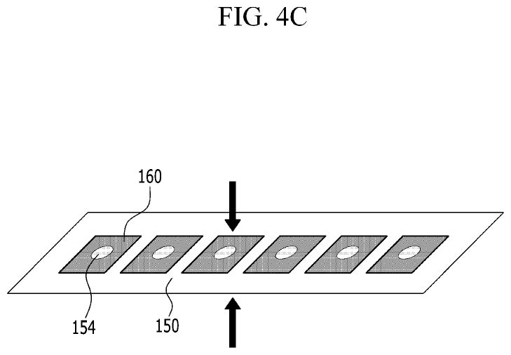

Further, the ultra-thin glass 160 is laminated to the flexible film 150 (refer to FIG. 4A to FIG. 4C).

In this step, a liquid material 154 is applied to the flexible film 150 (refer to FIG. 4A), the ultra-thin glass 160 is disposed on the liquid material 154 (refer to FIG. 4B), and the flexible film 150 is laminated to the ultra-thin glass 160 by pressurizing the flexible film 150 and the ultra-thin glass 160 (refer to FIG. 4C).

Here, the liquid material 154 may include a high-volatility organic solvent. For example, the liquid material may include isopropyl alcohol, but it is not limited thereto.

During the process for laminating the flexible film 150 and the ultra-thin glass 160 by pressurizing the flexible film 150 and the ultra-thin glass 160, the liquid material 154 may leak to the outside, and the liquid material may be positioned on an opposite side of a side that faces the flexible film 150 on the ultra-thin glass 160. When the ultra-thin glass 160 is laminated to the substrate 130 to which an adhesive is applied while part of the liquid material is applied to one side of the ultra-thin glass 160, the liquid material and the adhesive 136 may chemically react with each other, so performance of the electronic element 132 may be deteriorated, or erroneous operations may be generated. The liquid material 154 according to an exemplary embodiment has high volatility, so it may become volatile and may be removed when it leaks during the pressurization process, the reaction to the adhesive 136 may be accordingly minimized, and deterioration of performance of the electronic element 132 or erroneous operations may be prevented.

The ultra-thin glass 160 may be laminated to the flexible film 150 by attraction between the flexible film 150 and the liquid material 154 and attraction between the liquid material 154 and the ultra-thin glass 160. In detail, molecules of the liquid material 154 may fill an empty space of a fine surface structure (a fine protrusions and depressions structure) of the flexible film 150 and the ultra-thin glass 160, and may perform an adhering function. By use of the flexible film 150, the ultra-thin glass 160 may be safely handled, its damage may be prevented, it may be minimized to break the ultra-thin glass 160 or generate defects while there is a process for washing the ultra-thin glass 160 before the substrate 130 is laminated, and a user does not touch the ultra-thin glass 160, thereby preventing contamination. In addition, adherence of the liquid material 154 has intensity that may not damage the ultra-thin glass 160 when it is attached or detached, so the damage of the ultra-thin glass 160 may be minimized when the flexible film 150 is separated from the ultra-thin glass 160.

For example, when the liquid material 154 is isopropyl alcohol, adherence that is enough to lift the ultra-thin glass 160 must be generated, and the adherence may be equal to or greater than about 4.83×10⁻² N.

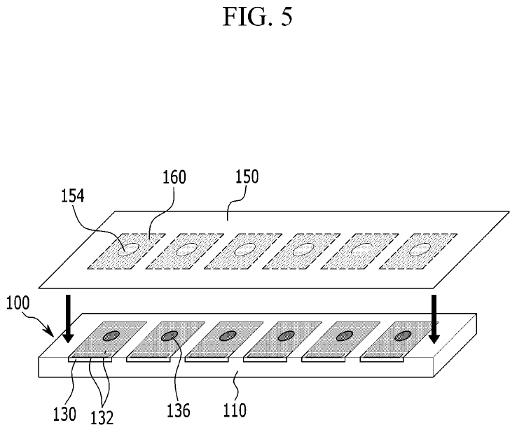

An adhesive 136 is applied to at least part of one side of the substrate 130 (refer to FIG. 5).

In detail, the adhesive 136 may be applied to an insulating layer (not shown) or a passivation layer (not shown) positioned on the substrate 130 or the electronic element 132. The adhesive 136 may include, for example, a UV curing adhesive.

The flexible film 150 is disposed so that the side to which the ultra-thin glass 160 is laminated on the flexible film 150 may face one side of the substrate 130, and the ultra-thin glass 160 is laminated to the substrate 130 to which an adhesive is applied (refer to FIG. 5).

While the ultra-thin glass 160 is disposed at a predetermined gap on the flexible film 150, the same may be disposed on the lamination jig 100 to thus allow precise alignment, and the same may be laminated to the substrate 130 without damaging the ultra-thin glass 160.

A contaminated material may further be removed from the surface of the ultra-thin glass 160 as a washing step before the ultra-thin glass 160 is laminated to the substrate 130 to which an adhesive is applied. In this instance, as the ultra-thin glass 160 is laminated to the flexible film 150, the ultra-thin glass 160 may not be damaged but may be washed in a stable way.

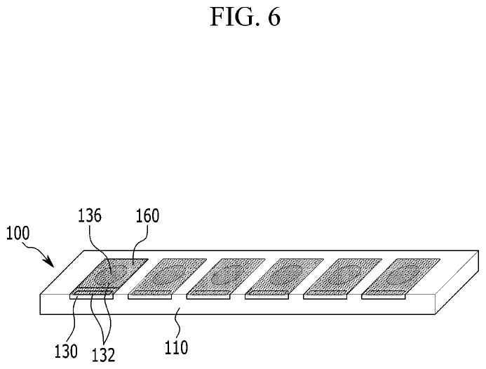

The flexible film 150 is separated from the ultra-thin glass 160 (refer to FIG. 6).

The ultra-thin glass 160 and the flexible film 150 are laminated by the liquid material 154 with relatively low adherence compared to the adherence of the adhesive 136, so the flexible film 150 may be easily separated from the ultra-thin glass 160 without damaging the ultra-thin glass 160.

When the flexible film 150 is separated, a stacked structure of the substrate 130, the electronic element 132, the adhesive 136, and the ultra-thin glass 160 is positioned on the substrate mounting unit 120 of the lamination jig 100, and when a pressure is applied in the step for forming a laminate structure given below, the laminate structure 190 may be formed.

In the step for forming a laminate structure 190, the substrate 130 and the ultra-thin glass 160 are pressurized.

Here, the pressurizing method may be a method for allowing the lamination jig 100 to pass between a pair of rollers 184 and applying pressure to the substrate 130 and the ultra-thin glass 160 (refer to FIG. 8). When the lamination jig 100 passes through the rollers 184, the pressure is supplied to the substrate 130 from the substrate mounting unit 120 of the lamination jig 100, the pressure is applied to the ultra-thin glass in the opposite side, and the adhesive 136 is cured, so the ultra-thin glass 160 may be firmly combined to the substrate 130.

In this step, a portion of the adhesive 136 may leak because of pressurization. The leaking adhesive 136 may be discharged to the discharging hole 124, so generation of defects to the electronic element may be minimized, and the ultra-thin glass 160 or the substrate 130 may not be contaminated.

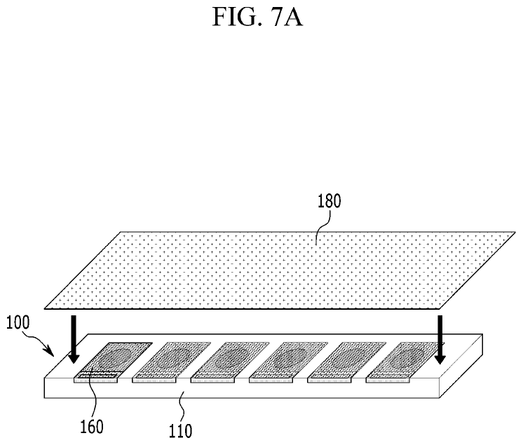

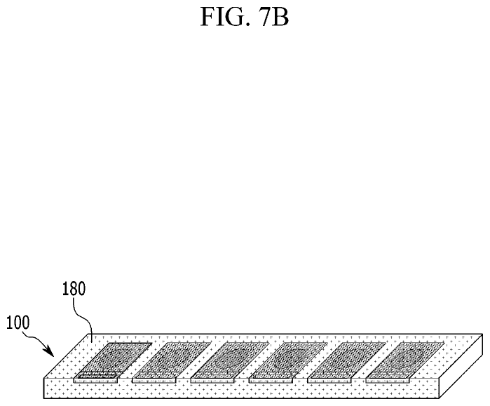

In addition, before the lamination jig 100 is allowed to pass between a pair of rollers 184 and is pressurized, the ultra-thin glass 160 may be wrapped with an absorbing sheet 180 and may be allowed to pass through the lamination jig 100 between the rollers 184 (refer to FIG. 7A, FIG. 7B, and FIG. 8).

The absorbing sheet 180 may absorb the adhesive 136 leaking from the ultra-thin glass 160 in the case of pressurization by a roller, so adherence may be generated between the ultra-thin glass and the absorbing sheet 180, and movement of the ultra-thin glass 160 may be prevented in the case of pressurization by the generation of adherence. Here, the movement of the ultra-thin glass 160 signifies that the lamination jig 100 passes through the roller 184 and the ultra-thin glass 160 leaves the substrate mounting unit 120, and when the ultra-thin glass 160 moves, it may be damaged.

The absorbing sheet 180 may include a cellulose material such as wood pulp or endo-pulp, and liquid absorbing performance of the absorbing sheet 180 may be about 3 ml/g to 50 ml/g. Further, the absorbing sheet 180 may additionally include a polymer material such as polyethylene terephthalate (PET) or polyvinyl alcohol (PVA).

Referring to FIG. 9, while the pressure is increased by the roller 184, the adhesive material may be discharged to the discharging hole 124b through the first path P1, or it may be absorbed into the absorbing sheet 180 through the second path P2 and may generate adherence between the absorbing sheet 180 and the ultra-thin glass 160.

For example, the laminate structure 190 manufactured by the ultra-thin glass laminating method according to an exemplary embodiment may include a substrate 130, an ultra-thin glass 160, and an adhesive layer positioned between the substrate 130 and the ultra-thin glass 160 and formed by curing the adhesive 136 (refer to FIG. 10). By the laminating method, the thickness of the adhesive layer 138 of the laminate structure 190 may be 1 μm to 20 μm, and it may form a very thin adhesive layer compared to the conventional laminate structures.

Here, the above-noted predetermined depth (dₛ) may be set to correspond to the summation of the thicknesses of the substrate 130, the electronic element 132, the ultra-thin glass 160, and the adhesive layer 138. By this, during the lamination process, the substrate 130 and the ultra-thin glass 160 may be fixed and their digression is prevented, so the laminate structure 190 may be stably formed, damaging of the ultra-thin glass 160 may be minimized, and the manufacturing cost may be resultantly reduced.

The predetermined depth (dₛ) may be set to be greater than the summation of the thicknesses of the substrate 130, the electronic element 132, the ultra-thin glass 160, and the adhesive layer 138. In this case, the predetermined depth (dₛ) may further include a thickness of a carrier (not shown) for carrying the substrate 130. In addition, the predetermined depth (dₛ) may further include a thickness of a passivation unit (not shown) for protecting a lower side (an opposite side of a side on which the electronic element is positioned) of the substrate 130 from the adhesive or physical damage.

A configuration of a laminate structure manufactured by the ultra-thin glass laminating method according to exemplary embodiments will now be described with reference to FIG. 10.

The laminate structure 190 on which ultra-thin glass is laminated includes a substrate 130, a capacitive fingerprint sensor 132, ultra-thin glass 160 positioned on the fingerprint sensor 132, and an adhesive layer 138 positioned between the fingerprint sensor 132 and the ultra-thin glass 160 and laminating the fingerprint sensor 132 and the ultra-thin glass 160.

By the laminating method according to exemplary embodiments, the thickness of the ultra-thin glass 160 in the laminate structure 190 may be 1 μm to 100 μm, the thickness of the adhesive layer 138 may be 1 μm to 20 μm, and the thicknesses of the ultra-thin glass 160 and the adhesive layer 138 are very much less than the thicknesses of the glass and the adhesive layer of the conventional laminate structures.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 100: lamination jig | 110: base plate |
| 120: substrate mounting unit | 124, 124a, 124b: discharging hole |
| 130: substrate | 132: electronic element |
| 136: adhesive | 138: adhesive layer |
| 150: flexible film | 154: liquid material |
| 160: ultra-thin glass | 180: absorbing sheet |
| 184: roller | 190: laminate structure |

What is claimed is:

1. A lamination jig for adhering ultra-thin glass to a substrate on which an electronic element is installed on one side, comprising:
a base plate having a predetermined depth, and including at least one substrate mounting unit into which the substrate is inserted and fixed; and
at least one discharging hole installed in the base plate with at least part thereof overlapping the substrate mounting unit.

2. The lamination jig of claim 1, wherein
the discharging hole is positioned on a boundary of the substrate mounting unit and part thereof overlaps the substrate mounting unit.

3. The lamination jig of claim 1, wherein
the discharging hole is positioned on the substrate mounting unit and entirely overlaps the substrate mounting unit.

4. The lamination jig of claim 1, wherein
an adhesive is applied to the substrate fixed to the substrate mounting unit, the ultra-thin glass is positioned on the adhesive, pressure is applied to the substrate and the ultra-thin glass, and part of the adhesive is discharged to the discharging hole.

5. The lamination jig of claim 1, wherein
the base plate includes a plurality of the substrate mounting units, and
the substrate mounting units have different sizes or shapes.

6. The lamination jig of claim 1, wherein
the base plate includes a plurality of the discharging holes, and
the discharging holes have different sizes or shapes.

7. An ultra-thin glass laminating method comprising:
mounting a substrate on which an electronic element is installed on one side on lamination jig;
laminating ultra-thin glass on a flexible film;
applying an adhesive to at least part of the one side of the substrate;
disposing the flexible film so that the side to which the ultra-thin glass is laminated may face the one side of the substrate on the flexible film, and laminating the ultra-thin glass to the substrate to which the adhesive is applied;
separating the flexible film from the ultra-thin glass; and
forming a laminate structure by pressurizing the substrate and the ultra-thin glass,
wherein the lamination jig includes
a base plate having a predetermined depth, and including at least one substrate mounting unit into which the substrate is inserted and fixed, and
at least one discharging hole installed in the base plate and at least part thereof overlapping the substrate mounting unit.

8. The ultra-thin glass laminating method of claim 7, wherein
a thickness of the ultra-thin glass is 1 μm to 100 μm.

9. The ultra-thin glass laminating method of claim 7, wherein
the laminating of ultra-thin glass on a flexible film includes
applying a liquid material to the flexible film, disposing the ultra-thin glass on the liquid material, and pressurizing the flexible film and the ultra-thin glass to laminate the flexible film and the ultra-thin glass.

10. The ultra-thin glass laminating method of claim 9, wherein
the liquid material includes a high-volatility organic solvent.

11. The ultra-thin glass laminating method of claim 7, wherein
the forming of a laminate structure includes
allowing part of the adhesive to be discharged to the discharging hole while pressurizing the substrate and the ultra-thin glass.

12. The ultra-thin glass laminating method of claim 7, wherein
the forming of a laminate structure includes
pressurizing the substrate and the ultra-thin glass while allowing the lamination jig to pass between a pair of rollers.

13. The ultra-thin glass laminating method of claim 12, wherein
the ultra-thin glass is covered with an absorbing sheet, the lamination jig is passed between the one pair of rollers, the substrate and the ultra-thin glass are pressurized, part of the adhesive leaks and is absorbed into the absorbing sheet, and adherence is generated between the absorbing sheet and the ultra-thin glass by the adhesive absorbed into the absorbing sheet.

14. The ultra-thin glass laminating method of claim 7, wherein
the laminate structure includes the substrate, the ultra-thin glass, and an adhesive layer positioned between the substrate and the ultra-thin glass and formed by curing the adhesive.

15. The ultra-thin glass laminating method of claim 14, wherein
a thickness of the adhesive layer is 1 μm to 20 μm.

16. The ultra-thin glass laminating method of claim 15, wherein
the predetermined depth is equal to or greater than a summation of thicknesses of the substrate, the electronic element, the ultra-thin glass, and the adhesive layer.

17. The ultra-thin glass laminating method of claim 7, further comprising,
before laminating the ultra-thin glass to the substrate to which the adhesive is applied,
performing a washing step for removing a contaminated material from a surface of the ultra-thin glass.

18. The ultra-thin glass laminating method of claim 7, wherein
the electronic element includes a fingerprint sensor.
